(19) United States
(12) Patent Application Publication
(10) Pub. No.: US 2009/0056416 A1
(43) Pub. Date: Mar. 5, 2009

(54) Ceramic Particulate Matter Sensor With Low Electrical Leakage

(76) Inventors: Balakrishnan G. Nair, Sandy, UT (US); Brett Henderson, Salt Lake City, UT (US); Gangqiang Wang, Salt Lake City, UT (US); Thomas Koemer Pace, Salt Lake City, UT (US)

Correspondence Address: CERAMATEC, INC., 2425 SOUTH 900 WEST, SALT LAKE CITY, UT, 84119, US

(21) Appl. No.: 12/203,070

(22) Filed: Sep. 2, 2008

Related U.S. Application Data
(60) Provisional application No. 60/969,056, filed on Aug. 30, 2007.

(51) Int. Cl. G01N 37/00

(52) U.S. Cl. 73/28.01; 73/28.02

(57) ABSTRACT

A ceramic particulate matter sensor to measure particulate matter within an exhaust stream. The particulate matter sensor includes a high voltage electrode on a first conductive layer and a detection electrode on a second conductive layer within a stack of ceramic layers. The stack of ceramic layers is bonded as a single rigid structure. The detection electrode generates a measurement of particulate matter within an exhaust stream. The particulate matter sensor also includes an insulating material positioned adjacent to the second conductive layer to insulate the detection electrode from another conductive layer within the stack of ceramic layers. The particulate matter sensor also includes an electrical heater to burn off an accumulation of contaminating particulate matter from at least one electrode of the high voltage and detection electrodes. The particulate matter sensor also includes means for substantially preventing electrical leakage through the insulating material to the second conductive layer.

### CROSS-REFERENCE TO RELATED APPLICATIONS

This application claims the benefit of U.S. Provisional Application No. 60/969,056, filed on Aug. 30, 2007, which is incorporated by reference herein in its entirety.

### BACKGROUND

Internal combustion engines (e.g., diesel engines) typically generate an exhaust flow that contains varying amounts of particulate matter (PM). The amount and size distribution of particulate matter in the exhaust flow tends to vary with engine operating conditions, such as fuel injection timing, injection pressure, or the engine speed to load relationship. Adjustment of these conditions may be useful in reducing particulate matter emissions and particulate matter sizes from the engine. Reducing particulate matter emissions from internal combustion engines is environmentally favorable. In addition, particulate matter measurements for diesel exhaust is useful for on-board (e.g., mounted on a vehicle) diagnostics of PM filters and reduction of emissions through combustion control.

Conventional technologies that can be used for on-board monitoring of particulate matter in exhaust flows include wire and ceramic sensors. Both types of sensors apply a high voltage to one of two electrodes and measure the current or charge on the other electrode. The electrode measurement is correlated with a specific particulate matter concentration. Wire sensors use conductive wires as the electrodes. Ceramic sensors use conductive traces, which are disposed on ceramic substrates, as the electrodes. Some ceramic sensors are superior to wire sensors at least because they are easier to manufacture, cost less than wire sensors, and are more robust in adverse operating environments. By way of comparison, ceramic-based electrodes are more rigid than wire electrodes and, hence, vibrate less, maintain a more consistent distance between the electrodes, and produce less noise in the resulting electrical signal. However, both wire and ceramic sensors are subject to the de-calibration and baseline drift of the sensor due to accumulation of soot (i.e., particulate matter) on and between the electrodes. Additionally, conventional wire sensors have a limited area where the electrodes face each other, so the resulting sensor signals may be relatively small.

For wire sensors, a conventional solution to remove the soot from the electrodes implements a wire coil heater wound around the electrodes to heat the electrodes and burn off the accumulated soot. Although the wire coil implementation is one potential solution to removing accumulated soot from wire electrodes, the performance of the wire coil can fluctuate and even fail if, for example, the wire coil “burns out” similar to a filament in a light bulb.

For ceramic sensors, electrode heaters can be integrated into the ceramic sensor structure to burn off soot at the electrodes. However, the electrode heaters can significantly increase the temperature of the electrodes. By increasing the temperature of the electrodes at the same time that a high voltage is applied to the electrodes (e.g., one of the electrodes) can result in electrical leakage through the ceramic materials because the increase temperature decreases the insulating properties of the ceramic materials. This type of electrical leakage can impair the accuracy of the sensor measurements.

### SUMMARY

Embodiments of an apparatus are described. In one embodiment, the apparatus is a ceramic particulate matter sensor to measure particulate matter within an exhaust stream. As referred to herein a ceramic sensor refers to a sensor formed with multiple ceramic layers, which may have conductive materials disposed on or between the various ceramic layers. The conductive layers may be bonded to the ceramic layers using firing, deposition, or other techniques. Ultimately, the ceramic layers are bonded to form a single sensor structure. In some embodiments, the ceramic layers are co-fired in a single firing step to form a single rigid structure. In other embodiments, the ceramic layers are fired separately and then bonded together using a bonding agent.

One embodiment of the ceramic particulate matter sensor includes a high voltage electrode and a detection electrode. The high voltage electrode is on a first conductive layer within a stack of ceramic layers. The stack of ceramic layers is bonded as a single rigid structure. The detection electrode is on a second conductive layer within the stack of ceramic layers. The detection electrode is positioned relative to the high voltage electrode to generate a measurement of particulate matter within an exhaust stream between the high voltage electrode and the detection electrode. The particulate matter sensor also includes an insulating material positioned adjacent to the second conductive layer, which includes the detection electrode. The insulating material electrically insulates the detection electrode from another conductive layer within the stack of ceramic layers. The particulate matter sensor also includes an electrical heater positioned relative to the high voltage and detection electrodes to burn off an accumulation of contaminating particulate matter from at least one electrode of the high voltage and detection electrodes. The particulate matter sensor also includes means for substantially preventing electrical leakage through the insulating material to the second conductive layer. In this way, the means for substantially preventing electrical leakage isolate the charge, current, or voltage, on the detection electrode from potential corrupting signals from other conductive layers within the ceramic particulate matter sensor

In a more specific embodiment, the means for substantially preventing electrical leakage through the insulating material includes a ceramic material used for the insulating material. The ceramic material may be a highly pure alumina such as 99.9% pure alumina. Alternatively, the ceramic material may be a material with a relatively high electrical resistivity such as 100 M-ohms. In some embodiments, the ceramic material has an electrical stability during application of a high voltage of, for example, 3,000 V or higher to the ceramic material. Other embodiments of the ceramic material as the means for substantially preventing electrical leakage through the insulating material are also described.

In other embodiments, the means for substantially preventing electrical leakage through the insulating material includes means for imparting a surface charge to at least some of the particulate matter within the exhaust stream prior to passage between the high voltage electrode and the detection electrode. One example of means for imparting a surface charge is a precharging electrode. The precharging electrode can be embodied in various shapes and sizes. A high voltage (e.g., up to about 10,000 V) may be applied to the precharging electrode.

In other embodiments, the means for substantially preventing electrical leakage through the insulating material includes a double-walled sensor housing to contain the high voltage electrode, the detection electrode, and the insulating material. The double-walled sensor housing enables the particulate matter sensor to operate at a relatively low operating power. In particular, an outer wall shields an inner wall against the heat removal by the exhaust stream, so the particulate matter sensor can operate using at a lower operating power. While the double-walled sensor housing may not directly provide for lower electrical leakage, for example, through the insulating material, embodiments of the double-walled sensor housing may allow the particulate matter sensor to operate at a lower temperature since less power may be consumed to operate the heaters. Thus, embodiments of the double-walled sensor housing can indirectly facilitate lower electrical leakage by allowing the particulate matter sensor to operate at lower temperatures.

Some embodiments may combine two or more of the various structures described herein. Other embodiments of the particulate matter sensor and the means for substantially preventing electrical leakage through the insulating material are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1A depicts an exploded view of one embodiment of a ceramic particulate matter sensor that may be fabricated using a co-fired sintering technique.

FIG. 1B depicts a consolidated view of the ceramic particulate matter sensor of FIG. 1A.

FIG. 2A depicts an exploded view of one embodiment of a ceramic particulate matter sensor that may be fabricated using a bonding technique.

FIG. 2B depicts a consolidated view of the ceramic particulate matter sensor of FIG. 2A.

FIG. 3 depicts a schematic diagram of a one embodiment of a mounting structure for the particulate matter sensor of FIG. 1A.

FIG. 4 depicts a schematic diagram of one embodiment of a particulate matter sensor with a precharging electrode.

FIG. 5 depicts a schematic block diagram of one embodiment of a particulate measurement system.

Throughout the description, similar reference numbers may be used to identify similar elements.

### DETAILED DESCRIPTION

In the following description, specific details of various embodiments are provided. However, some embodiments may be practiced without at least some of these specific details. In other instances, certain methods, procedures, components, and circuits are not described in detail for the sake of brevity and clarity, but are nevertheless understood from the context of the description herein.

In general, the described embodiments are directed to a ceramic particulate matter (PM) sensor with low electrical leakage. Each of the described embodiments of the particulate matter sensor includes a means for substantially preventing electrical leakage through an insulating layer adjacent to a conductive layer which includes a detection electrode of the particulate matter sensor. Additionally, some embodiments facilitate failure notification to notify a user that an emission control system might be inoperable. Also, some embodiments provide feedback to an engine control system in order to optimize combustion. Other embodiments may be used for other new or improved emission management functions.

The basic configuration of at least one embodiment of the PM sensor includes a two electrode structure containing a high voltage electrode and a detection electrode. Each electrode is on a separate conductive layer within the PM sensor. The conductive layers are interposed between ceramic insulating layers. A high voltage is applied to the high voltage electrode and, under the application of this voltage, the particulate matter can be measured either by measuring a charge that accumulates on the detection electrode or, alternatively, by measuring an output voltage generated by the accumulated charge on the detection electrode.

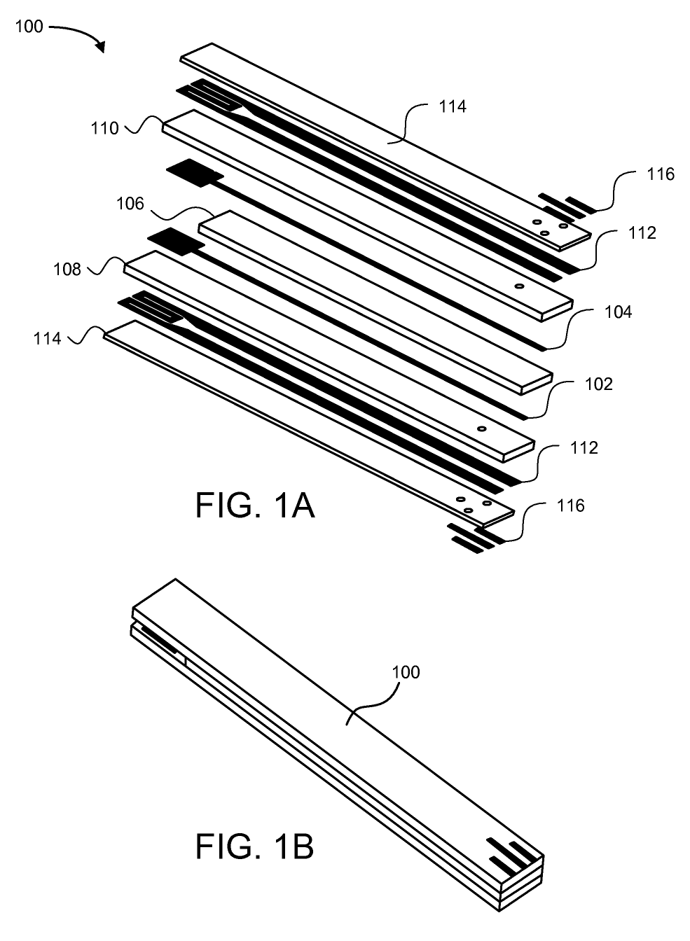

FIG. 1A depicts an exploded view of one embodiment of a ceramic particulate matter sensor 100 that may be fabricated using a co-fired sintering technique. The illustrated particulate matter sensor 100 includes a high voltage electrode 102 and a detection electrode 104 separated by an insulating material 106. The insulating material 106 is also referred to as a spacer.

It should be noted that references herein to the insulating material 106 being located between the high voltage electrode 102 and the detection electrode 104 simply means that some of the insulating material 106 is located in a layer that is between the conductive layers in which the high voltage and detection electrodes 102 and 104 are disposed. However, portions of the high voltage and detection electrodes 102 and 104 are exposed to an exhaust stream so that these portions are not covered by the insulating material 106. Additionally, the exposed portions of the high voltage and detection electrodes 102 and 104 are facing one another, in many implementations, so that the insulating material 106 is between the corresponding conductive layers of the high voltage and detection electrodes 102 and 104, but the insulating material 106 is not between the exposed portions of the high voltage and detection electrodes 102 and 104. For ease of describing the location of the insulating material 106, many embodiments may be considered to have the insulating material 106 between the lead portions of the high voltage and detection electrodes 102 and 104, while the active sensing portions of the high voltage and detection electrodes 102 and 104 do not have the insulating material 106 therebetween.

In some embodiments, the physical configuration of the high voltage and detection electrodes 102 and 104 and the insulating material 106 results in a very small distance between the high voltage electrode 102 and the detection electrode 104 to allow an air gap between the high voltage and detection electrodes 102 and 104. The air gap between the high voltage and detection electrodes 102 and 104 permits a flow of the exhaust stream to enter between the high voltage and detection electrodes 102 and 104. As one example, the distance, or gap, between the high voltage and detection electrodes 102 and 104 may be as small as approximately 1 mm. For example, in some embodiments, the gap may be between about 0.5 and 1.0 mm. In other embodiments, the gap may be approximately a few millimeters. Alternatively, the distance between the high voltage and detection electrodes 102 and 104 may be as large as 1 cm. In one embodiment, the distance between the high voltage electrode 102 and the detection electrode 104 is within a range of about 0.5-2.0 mm. Other embodiments may implement other distances between the high voltage and detection electrodes 102 and 104.

The high voltage electrode 102 is disposed on a high voltage electrode substrate 108. Similarly, the detection electrode is disposed on a detection electrode substrate 110. In one embodiment, the high voltage electrode substrate 108 and the detection electrode substrate 110 are insulating substrates, and the high voltage electrode 102 and the detection electrode 104 are conductive layers disposed on the corresponding substrates 108 and 110.

The conductive layer applied to the surface of the insulating substrates 108 and 110 includes an electrode (i.e., the active sensing portion), an electrode contact, and an electrode trace (i.e., the lead portion) connecting the electrode to the electrode contact. In general, the electrode is used in conjunction with another electrode to detect particulate matter in the surrounding environment such as an exhaust stream. The electrode trace carries an electrical signal (e.g., a charge, current, or voltage) to the electrode contact, which facilitates an electrical connection to a controller or other device. For ease of explanation, references to the electrode generally may refer specifically to the active sensing portion of the conductive layer or may refer to the entire conductive layer with the active sensing portion as well as the electrical lead and contact portions. In one embodiment, the conductive layer is formed of platinum (Pt). Other embodiments may use other conductive materials such as tungsten (W), molybdenum (Mo), molybdenum/manganese (Mo/Mn), or another conductive material.

The conductive layer of each of the high voltage and detection electrodes 102 and 104 may be disposed on the corresponding substrates 108 and 110 using any suitable technology. In some embodiments, the conductive layer may be applied to the surface of the substrate 108 or 110 using a thick film fabrication, or formation, method. Some examples of thick film fabrication methods include screen printing and sputtering, although other thick film fabrication methods may be used. In some embodiments, the conductive layer may be applied to the surface of the electrode substrate 108 or 110 using a thin film fabrication, or formation, the method. Some examples of thin film fabrication methods include vacuum deposition techniques such as chemical and physical vapor deposition, although other thin film fabrication methods may be used. By using a thick or thin film fabrication method, the effective area of the electrode 104 may be relatively large in order to provide a relatively strong electrical signal.

The depicted particulate matter sensor 100 also includes one or more heaters 112, cover plates 114, and electrical contact pads 116. In many aspects, the heaters 112 are conductive layers which are similar to the high voltage and detection layers 102 and 104, although the heaters 112 are generally used generate heat, rather than to obtain an electrical signal. The heaters 112 may be formed using thick or thin film fabrication methods to form conductive traces on a ceramic or otherwise insulating substrate. Additionally, the heaters 112 may be formed on the same substrates 108 and 110 as the high voltage and detecting electrodes 102 and 104. Alternatively, the heaters 112 may be formed on different substrates.

Although multiple heaters 112 are shown, other embodiments may include a single heater 112, more than two heaters 112, or other quantities and/or arrangements of heaters 112. Additionally, the implementation of one or more heaters 112 within the ceramic layers of the particulate matter sensor 100 does not preclude the use of additional heaters (not shown) such as a separate coil, planar, or other heater outside of the ceramic layers of the particulate matter sensor 100.

The primary function of the heaters 112 in the particulate matter sensor 100 is to prevent failure or malfunctioning of the particulate matter sensor 100 due to deposition of conductive particulate matter species such as soot on the high voltage and detection electrodes 102 and 104. Deposition of soot can lead to a shorting between the high voltage and detection electrodes 102 and 104, resulting in a failure or malfunction of the particulate matter sensor 100. The built in heaters 112 can be used to combust off soot continuously or periodically so as to keep the high voltage and detection electrodes 102 and 104 clean of soot and, thus, preventing the shorting. The heaters 112 can also be used to burn off soot and prevent a conductive path from forming between one of the electrodes 102 and 104 and another conductive material within the particulate matter sensor 100, including the sensor housing. Hence, the heaters 112 may facilitate preserving the functionality of and extending the lifetime off the particulate matter sensor 100. Whether the heaters 112 are operated continuously or periodically may be determined by a variety of factors such as the type of engine, engine operating conditions, the location off the particulate matter sensor 100 in the exhaust pipe, and so forth.

Although FIG. 1A shows a specific number of heaters 112 in a particular configuration, other embodiments may implement a different number of heaters 112 in similar or different arrangements. Also, the area that is heated by the heaters 112 can be relatively small by embedding the electrodes 102 and 104 within a co-fired ceramic structure. Additionally, one or more heaters 112 may be disposed on other substrates within the particulate matter sensor 100. Also, the heaters 112 may be controlled individually, or in groups of two or more, according to control schemes which turn on the heaters 112 continuously, turn on the heaters 112 when the engine is on, or only turn on the heaters 112 periodically. In the case of periodic operation, the frequency of the heater operation may be within a frequency range inclusive of a few milliseconds or only once very several thousand hours, or anywhere in between. The frequency of operation does not have to be regular and may vary over time. It is also possible to design electronics to detect when soot contamination may be occurring and operate one or more heaters 112 based on a schedule to prevent such contamination from becoming critical to the operation of the particulate matter sensor 100.

Heater control on the particulate matter sensor 100 may be achieved by incorporating one or more temperature sensors (not shown) inside the body of the particulate matter sensor 100. However, in some embodiments, accuracy of the temperature attained is not critical, so less expensive and less accurate control strategies that do not require a temperature sensor may be implemented. For example, the control strategy may be as simple as keeping the voltage on to the heater for a fixed period of time, the time being previously determined to be sufficient to reach and hold a sufficiently high temperature to effectively combust the soot. Alternatively, the resistance of the heater itself may be monitored and a feedback control mechanism based on heater resistance using current or previous data about the heater resistance may be used. Additional details about implementing the heaters 112 within the particulate matter sensor 100, as well as other general characteristics and fabrication methods, are available in U.S. patent application Ser. No. 12/111,080, entitled “PARTICULATE MATTER SENSOR,” which was filed on Apr. 28, 2008, which is incorporated by reference herein in its entirety.

In one embodiment, the cover plates 114 simply provide an insulating covering for the heaters 112. The electrical contact pads 116 are disposed on an exterior surface of the cover plates. The exposed electrical contact pads 116 facilitate an external electrical connection to the particulate matter sensor 100. In particular, the various electrical contact pads 116 may facilitate electrical connections for power to the heaters 112, bias voltages for the high voltage and/or detection electrodes 102 and 104, and measurement signals generated by the high voltage and/or detection electrodes 102 and 104. In order to allow some or all of these electrical connections, some of the cover plates 114 may include connection vias aligned with the corresponding electrical contact pads 116. Additionally, some of the interior insulating layers may include corresponding connection vias.

FIG. 1B depicts a consolidated view of the ceramic particulate matter sensor 100 of FIG. 1A. The particulate matter sensor 100 may be fabricated using any suitable method. In some embodiments, the insulating layers of the particulate matter sensor 100 are a ceramic material such as alumina. In some embodiments, the insulating layers are formed by a ceramic coating or layer that is deposited on another ceramic material. Alternatively, the ceramic coating or layer may be deposited on any metal material or on a high-temperature polymer layer.

In some embodiments, the ceramic layers of the particulate matter sensor are bonded together by sintering the layers together, or by using another bonding method. In embodiments in which the layers are sintered together, the high voltage and detection electrodes 102 and 104 may be disposed on the corresponding substrates 108 and 110 before the sintering process.

One method of fabricating a co-fired structure is using a conventional planar ceramic fabrication process involving tape-casting, tape-featuring, metallization, lamination, and sintering operations. The high voltage and detection electrodes 102 and 104 and the heater patterns 112 may be deposited onto green ceramic tape through a variety of thin or thick film metallization processes such as screen printing, chemical, or physical vapor deposition, or electron beam techniques. The ceramic may be any ceramic. Some embodiments utilize a ceramic with a very low electrical conductivity. Hence, the ceramic has a very high electrical resistance. Some embodiments utilize a ceramic with a relatively high stability under the application of high voltages to the high voltage and detection electrodes 102 and 104. One example of a ceramic that may be used in this application is alumina. In particular some embodiments utilize a high purity alumina with at least about 99% purity. Other embodiments utilize higher purity alumina with at least about 99.9% purity. Other embodiments may use other types of highly purified ceramic materials that have a very low electrical conductivity.

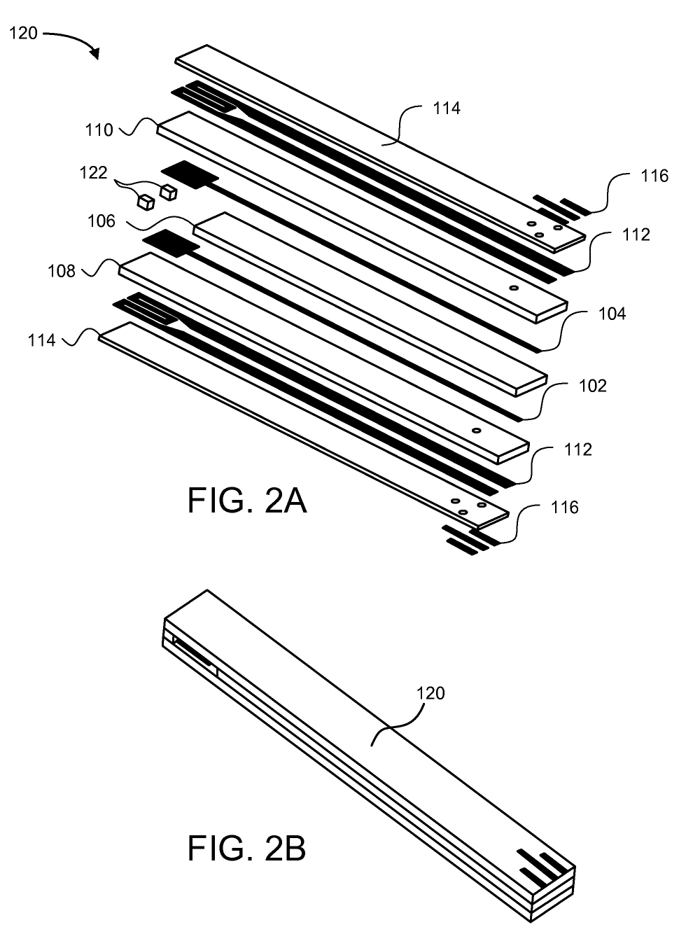

FIG. 2A depicts an exploded view of one embodiment of a ceramic particulate matter sensor 120 that may be fabricated using a bonding technique. In general, the particulate matter sensor 120 shown in FIG. 2A includes many of the same component layers as the particulate matter sensor 100 shown in FIG. 1A. In particular, the particulate matter sensor 120 shown in FIG. 2A includes the high voltage and detection electrodes 102 and 104 and corresponding substrates 108 and 110, an insulating material 106, heaters 112, cover plates 114, and electrical contact pads 116.

The depicted particulate matter sensor 120 also includes additional spacers 122 which are located between the high voltage and detection electrode substrates 108 and 110 at the electrode end of the particulate matter sensor 120. In other words, the spacers 122 are within the space substantially adjacent to the air gap between the high voltage and detection electrodes 102 and 104.

FIG. 2B depicts a consolidated view of the ceramic particulate matter sensor 120 of FIG. 2A. While the particulate matter sensor 120 may be formed by a co-sintering technique, embodiments of the particulate matter sensor 120 may be formed by a bonding technique where at least two separate structures are bonded together with a glass, metal, or another bonding material. In one embodiment, all of the different layers of the particulate matter sensor 120 are bonded to each other. In other embodiments, some of the layers may be sintered together into layer combinations, and then the resulting layer combinations may be bonded together.

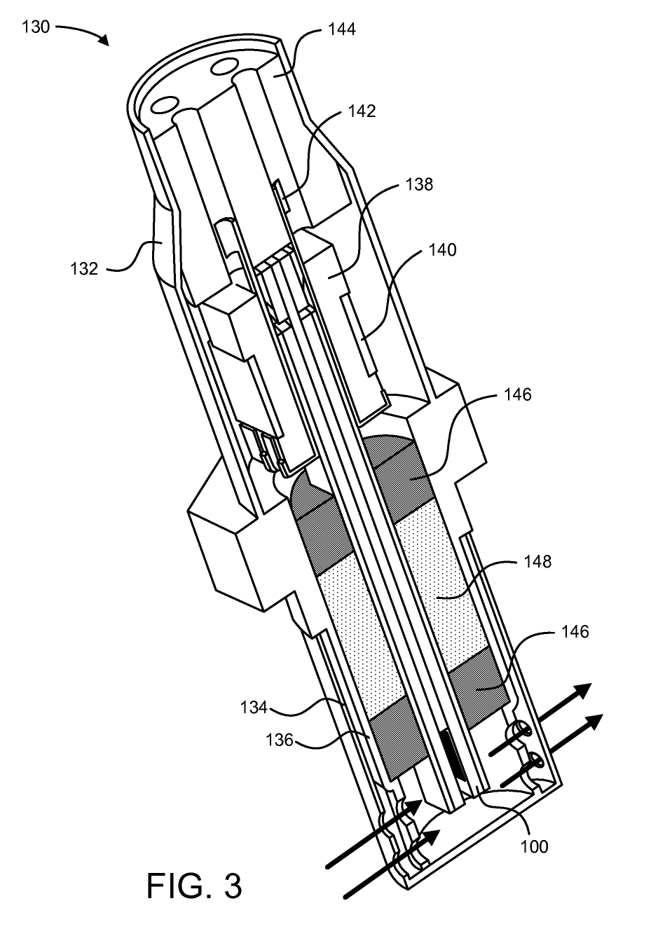

FIG. 3 depicts a schematic diagram of a one embodiment of a mounting structure 130 for the particulate matter sensor 100 of FIG. 1A. In particular, the particulate matter sensor 100 is mounted within a sensor housing 132. Although FIG. 3 shows the particulate matter sensor 100 of FIG. 1A mounted in the sensor housing 132, other particulate matter sensors may be mounted within the same or similar sensor housings.

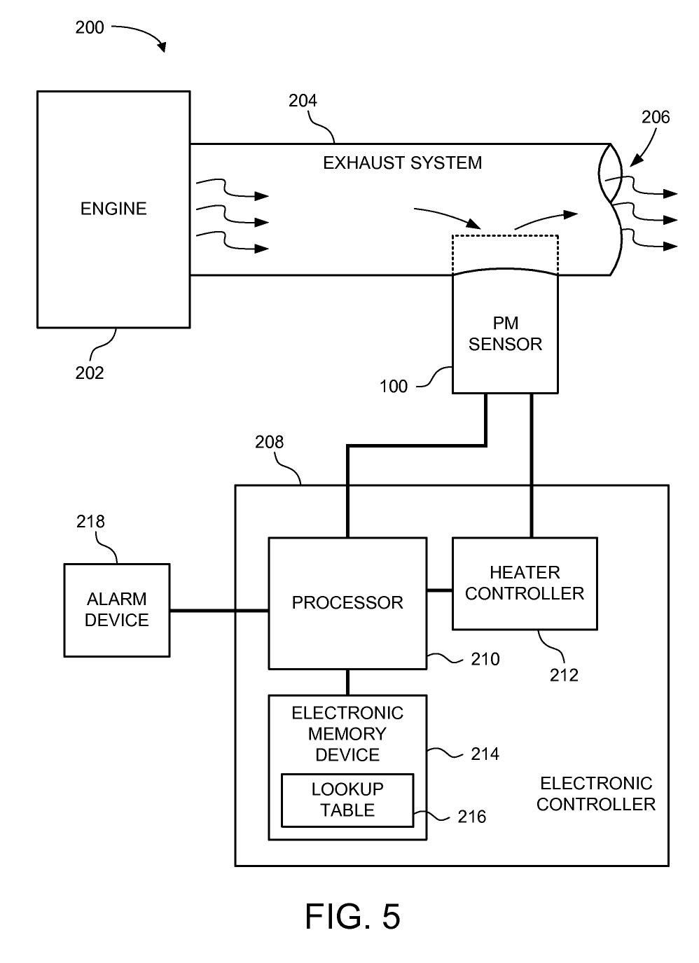

In one embodiment, the sensor housing 132 is a metal housing or another type of housing which offers environmental protection and structural support for the particulate matter sensor 100. In general, the sensor housing 132 facilitates mounting the particulate matter sensor 100 within an exhaust gas environment or other environment where measurements of particulate matter can be obtained. For example, a threaded neck (not shown) of the sensor housing 132 may facilitate mounting the particulate matter sensor 100 into a corresponding threaded hole in an exhaust gas system (refer to FIG. 5). When mounted in an exhaust gas system, the high voltage and detection electrodes 102 and 104 are exposed to a passing airstream such as an exhaust gas stream. Hence, the particulate matter sensor 100 is able to measure concentrations of particulate matter in the exhaust gas stream.

In one embodiment, at least a portion of the sensor housing 132 is formed with a double-walled metal tube. The double-walled metal tube includes an exterior wall 134 and an interior wall 134. The interior wall 136 forms an interior cavity to enclose at least a portion of the particulate matter sensor 100, including the high voltage electrode 102, the detection electrode 104, and the insulating material 106. The exterior wall 134 shields the interior wall 136 against the flow of the exhaust stream. In particular, the exterior wall 134 acts as a shield when the particulate matter sensor 100 is inserted in a high velocity exhaust flow environment. In the absence of the double-walled metal tube as the sensor housing 132, the exhaust stream might remove a significant amount of heat from the particulate matter sensor 100. By allowing heat to be removed from the particulate matter sensor 100, the temperature of the particulate matter sensor 100 would decrease and the particulate matter may not burn off. Hence, the heaters 112 within the particulate matter sensor 100 may consume more power in order to maintain a proper operating temperature to burn off the particulate matter at or near the high voltage and detection electrodes 102 and 104. In other words, the exhaust stream would cool off the particulate matter sensor I 00 and, as a result, the heaters 112 would consume more power to burn off the particulate matter. In one embodiment, apertures in the exterior and interior walls 134 and 136 allow some of the exhaust stream to enter and exit the interior cavity defined by the interior wall 136, as indicated by the arrows.

Although the depicted sensor housing 132 incorporates both the exterior and interior walls 132 and 134 in a single structure, other embodiments may achieve similar functionality using other configurations of two or more walls. For example, in some embodiments, one or more walls may be incorporated into a wall of the exhaust pipe. Alternatively, one or more walls may be mounted into the exhaust pipe separately from the sensor housing 132.

The illustrated mounting structure 130 also includes electrical carriers 138, carrier holding clips 140, and electrical terminal contacts 142. The electrical carriers 138 and carrier holding clips 140 facilitate electrical connections from the electrical contact pads 116 to the electrical terminal contacts 142. In one embodiment, the electrical terminal contacts 142 are located within a ceramic or other insulating grommet 144, or plug, at the end of the mounting structure 130. The grommet 144 allows the electrical terminal contacts 142 to be accessible for connections to external wires (not shown).

The illustrated mounting structure 130 also includes two sealant rings 146 and a pliable sealant 148. The sealant rings 146 circumscribe portions of the particulate matter sensor 100, including the high voltage and detection electrodes 102 and 104 and the insulating material 106. The sealant rings 146 are separate along the length of the particulate matter sensor 100 and the sensor housing 132 in order to form a sealant cavity between the sealant rings 146. The pliable sealant 148 is disposed within the cavity between the sealant rings 146. In this way, the pliable sealant 148 circumscribes at least a portion of the particulate matter sensor 100, including the high voltage and detection electrodes 102 and 104 and the insulating material 106.

In one embodiment, the presence of the sealant rings 146 and/or the pliable sealant 148 facilitates durability for the particulate matter sensor 100 within the sensor housing 132 from the standpoint of mechanical vibration and shock. Additionally, the sealant rings 146 and the pliable sealant 148 may create a seal within the sensor housing 132 to prevent contaminating particulate matter from depositing further within the sensor housing 132.

In one embodiment, the pliable sealant 148 is a powder sealant or a cement layer. One example of a powder sealant is a green compact. By using a powder sealant or cement layer, the sensor housing 132 may be crimped at the location of the pliable sealant 148, thus compacting the pliable sealant 148 and creating a substantially impervious seal. Alternatively, the pliable sealant 148 may be a melting sealant such as glass, which melts upon the application of sufficient heat and, thus, creates a substantially impervious seal. Other embodiments may use other types of pliable sealants 148.

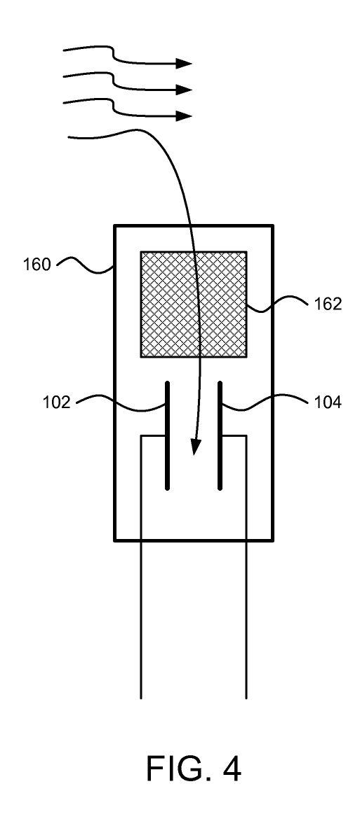

FIG. 4 depicts a schematic diagram of one embodiment of a particulate matter sensor 160 with a precharging electrode 162. The illustrated particulate matter sensor 160 also includes high voltage and detection electrodes 102 and 104, as described above. Additionally, the particulate matter sensor 160 may include one or more other components described above with reference to the particulate matter sensors 100 and 102 of FIGS. 1A and 2A.

A flow of particles in a tube can result in surface charging effects on the particles. The mass and/or number of charged particles can be quantified by measuring the surface charge on an electrode exposed to the charged particles. Depending on the magnitude of the measured signal at the electrode, the measured signal may be amplified by using a charge amplification device. This surface charge technology may be compatible with some on-board measurement systems which use particulate matter sensors due to the ability to use a relatively small detection electrode.

In one embodiment, a surface charge is imparted to the particulate matter within an exhaust stream (depicted by the arrows above the particulate matter sensor 160) by applying a high voltage relative to ground. As the exhaust stream passes by the particulate matter sensor 160, at least a portion of the exhaust stream enters the particulate matter sensor 160. In general, the precharging electrode 162 provides a precharging stage where some or all of the entering particulate matter is electrically charged due to the high voltage applied to the precharging electrode 162. Applying a high negative voltage to the precharging electrode 162 can result in the transfer of electrons from the surface of the precharging electrode 162 to the particulate matter within the exhaust stream. Applying a high positive voltage to the precharging electrode 162 can result in electrons being stripped from the particulate matter within the exhaust stream. It should be noted that embodiments of the precharging electrode 162 may use various voltage polarities and/or magnitudes to obtain different surface charging effects. In one embodiment, the voltage applied to the precharging electrode 162 is between about 0.1 and 10,000 Volts. In another embodiment, the applied voltage is between about 1 and 3000 Volts. Other embodiments may use other voltage ranges.

In some embodiments, the precharging electrode 162 is located in a region within or near the particulate matter sensor 160 where the gas will contact the precharging electrode 162 prior to contacting the high voltage electrode 102. While some embodiments of the particulate matter sensor 160 may include the precharging electrode 162 within the ceramic layers of the particulate matter sensor 160, other embodiments of the particulate matter sensor 160 may exclude the precharging electrode 162 and, instead, be located near one or more externally mounted precharging electrodes 162. For example, one or more precharging electrodes 162 may be mounted within the sensor housing 132 near the electrode end of the particulate matter sensor 100.

As explained above, the precharging electrode 162 is highly charged in order to impart an additional surface charge on any particles that may contact it. The precharging electrode 162 may be charged continuously or intermittently. The particulate matter concentration or characteristics such as number or area may measured by correlating with a current between the high voltage and detection electrodes 102 and 104 or a relative surface charge between the high voltage and detection electrodes 102 and 104 imparted by the charged particles.

Some examples of the precharging electrode 162 include a charged ring, cylinder, plate(s), mesh, honeycomb, or other manufacturable shapes. However, there is no limitation on the shapes of devices that can impart such a charge on the particulate matter within the exhaust stream. The material used to fabricate the precharging electrode 162 may be any conductive material, including materials which may be conductive by virtue of the application of a voltage to the material.

While the particulate matter sensor 160 is described herein as using the precharging electrode 162 to impart the surface charge to the particulate matter within the exhaust stream, it should be noted that there are several methods of imparting a surface charge to the particulate matter. Some additional examples of such method include the application of friction, temperature, plasma, or magnetization on the particulate matter.

FIG. 5 depicts a schematic block diagram of one embodiment of a particulate measurement system 200. The illustrated particulate measurement system 200 includes an engine 202 and an exhaust system 204. The exhaust system 204 is connected to the engine 202, which produces exhaust gases. The exhaust system 204 facilitates flow of the exhaust gases to an exhaust outlet 206.

In order to monitor particulate matter levels in the exhaust gas stream, the particulate matter (PM) sensor 100 measures concentrations of particulate matter, as described above. Since an accumulation of particulate matter on the high voltage and detection electrodes 102 and 104 of the particulate matter sensor 100 may degrade the performance of the particulate matter sensor 100, the particulate matter sensor 100 may include one or more heaters 112 to burn off combustible particulates that accumulate on or near the high voltage and detection electrodes 102 and 104. Some embodiments of the particulate measurement system 200 also may include one or more emissions control elements to emit neutralizing chemicals into the exhaust system 204 either before or after the particulate matter sensor 100.

The particulate matter sensor 100 is in electronic communication with an electronic controller 208. In general, the electronic controller 208 generates measurements of the particulate levels in the exhaust system 204. The measurements may be proportional or otherwise correlated with the signal levels generated by the particulate matter sensor 100. The electronic controller 208 also controls the operation of the heaters 112 within the particulate matter sensor 100.

The illustrated electronic controller 208 includes a processor 200, a heater controller 212, and an electronic memory device 214. The particulate matter sensor 100 communicates one or more electronic signals to the processor 210 of the electronic controller 208 using any type of data signal, including wireless and wired data transmission signals.

In one embodiment, the processor 210 facilitates execution of one or more operations of the particulate measurement system 200. In particular, the processor 210 may execute instructions stored locally on the processor 210 or stored on the electronic memory device 214. Additionally, various types of processors 210, include general data processors, application specific processors, multi-core processors, and so forth, may be used in the electronic controller 208.

In some embodiments, the processor 210 generates or controls a voltage bias for supply to the particulate matter sensor 100. For example, the processor 210 may control a separate power source within the electronic controller 208. The voltage bias facilitates increasing a voltage level of the least one of the high voltage and detection electrodes 102 and 108 relative to the other electrode. In one embodiment, the voltage bias may be in the range of approximately 1 to 10,000 Volts. As a more specific example, the voltage bias may be in the range of approximately 500 to 5,000 Volts. Other embodiments may use other voltage bias parameters. Similarly, the processor 210 may supply or control the application of the high voltage to a precharging electrode 162, as described above.

In some embodiments, the processor 210 may reference a lookup table 216 stored in the electronic memory device 214 in order to generate a measurement of the concentration of particulate matter within the exhaust system 204. Other embodiments may use other methods to correlate signal levels of the particulate matter sensor 100 with particulate measurement levels.

In one embodiment, the heater controller 212 controls the heaters 112 in the particulate matter sensor 100 to maintain specific operating temperatures for the corresponding high voltage and detection electrodes 102 and 104. The heater controller 212 may operate the heaters 112 continuously, periodically, or on some other non-continuous basis. In one embodiment, the heater controller 212 operates the heaters 112 within a temperature range of approximately 200° C. or higher. In some embodiments, the heater controller 212 operates the heaters 112 within a temperature range of approximately 400° C. or higher. Other embodiments may operate the heaters 112 at other temperatures.

It should also be noted that the particulate matter sensor 100 may be used, in some embodiments, to determine a failure in the particulate measurement system 200. For example, the particulate matter sensor 100 may be used to determine a failure of a particulate matter filter (not shown), or trap, within the exhaust system 204. In one embodiment, a failure within the particulate measurement system 200 may be detected by an elevated signal generated by the particulate matter sensor 100. Upon detection of a failure, the processor 210 may send a signal to a remote alarm device 218 such as a visual light indicator or an audio speaker device to notify a user of the detected failure.

It should also be noted that embodiments of the particulate matter sensor 100 may be tolerant of fluctuations of certain gaseous constituents in an exhaust gas environment. In this way, the particulate matter sensor 100 may be calibrated to measure particular chemicals or materials within an exhaust gas environment.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A ceramic particulate matter sensor comprising:
a high voltage electrode on a first conductive layer within a stack of ceramic layers, wherein the stack of ceramic layers is bonded as a single rigid structure;
a detection electrode on a second conductive layer within the stack of ceramic layers, the detection electrode positioned relative to the high voltage electrode to generate a measurement of particulate matter within an exhaust stream between the high voltage electrode and the detection electrode;
an insulating material positioned adjacent to the second conductive layer to electrically insulate the detection electrode from another conductive layer within the stack of ceramic layers;
an electrical heater positioned relative to the high voltage and detection electrodes to burn off an accumulation of contaminating particulate matter from at least one electrode of the high voltage and detection electrodes; and
means for substantially preventing electrical leakage through the insulating material to the second conductive layer.

2. The ceramic particulate matter sensor of claim 1, wherein the insulating material comprises a ceramic material with at least about 99% pure alumina.

3. The ceramic particulate matter sensor of claim 2, wherein the ceramic material is least about 99.9% pure alumina.

4. The ceramic particulate matter sensor of claim 1, wherein the insulating material comprises a ceramic material with an electrical resistivity of at least about 20 M-ohms.

5. The ceramic particulate matter sensor of claim 4, wherein the electrical resistivity of the ceramic material is at least about 100 M-ohms.

6. The ceramic particulate matter sensor of claim 1, wherein the insulating material comprises a ceramic material with an electrical stability during application of a high voltage of at least about 3,000 V to the ceramic material.

7. The ceramic particulate matter sensor of claim 1, wherein the means for substantially preventing electrical leakage through the insulating material comprises means for imparting a surface charge to the particulate matter within the exhaust stream prior to passage between the high voltage electrode and the detection electrode.

8. The ceramic particulate matter sensor of claim 7, wherein the means for imparting the surface charge to the particulate matter comprises a precharging electrode to charge the particulate matter.

9. The ceramic particulate matter sensor of claim 8, wherein the precharging electrode comprises a conductive ring.

10. The ceramic particulate matter sensor of claim 8, wherein the precharging electrode comprises a conductive cylinder.

11. The ceramic particulate matter sensor of claim 8, wherein the precharging electrode comprises a conductive plate.

12. The ceramic particulate matter sensor of claim 8, further comprising a power source coupled to the precharging electrode, wherein the power source is configured to supply a voltage signal to the precharging electrode, wherein the voltage signal is between about 0.1 V and 10,000 V.

13. The ceramic particulate matter sensor of claim 12, wherein the voltage signal is between about 1 V and 3,000 V.

14. The ceramic particulate matter sensor of claim 13, wherein the voltage signal is between about 500 V and 1,500 V.

15. The ceramic particulate matter sensor of claim 14, wherein the voltage signal is about 1,000 V.

16. The ceramic particulate matter sensor of claim 12, wherein the power source is further configured to continuously supply the voltage signal to the precharging electrode.

17. The ceramic particulate matter sensor of claim 12, wherein the power source is further configured to intermittently supply the voltage signal to the precharging electrode.

18. The ceramic particulate matter sensor of claim 12, wherein the power source is further coupled to the high voltage electrode, and wherein the power source is further configured to supply a second voltage signal to the high voltage electrode, wherein the second voltage signal is less than the voltage signal supplied to the precharging electrode.

19. The ceramic particulate matter sensor of claim 18, wherein the second voltage signal is between about 0 V and 5,000 V.

20. The ceramic particulate matter sensor of claim 19, wherein the second voltage signal is between about 1 V and 1,500 V.

21. The ceramic particulate matter sensor of claim 18, further comprising an electronic controller coupled to the high voltage electrode and the detection electrode, wherein the electronic controller is configured to determine the measurement of the particulate matter within the exhaust stream.

22. The ceramic particulate matter sensor of claim 21, wherein the electronic controller is further configured to measure an accumulated charge on the detection electrode, wherein the accumulated charge on the detection electrode corresponds to the charged particulate matter.

23. The ceramic particulate matter sensor of claim 21, wherein the electronic controller is further configured to measure an output voltage of the high voltage and detection electrodes, wherein the output voltage of the high voltage and detection electrodes corresponds to the charged particulate matter.

24. The ceramic particulate matter sensor of claim 1, wherein the means for substantially preventing electrical leakage through the insulating material comprises a double-walled sensor housing to contain the high voltage electrode, the detection electrode, and the insulating material, wherein the double-walled sensor housing enables the particulate matter sensor to operate at a relatively low operating power.

25. The ceramic particulate matter sensor of claim 24, wherein the double-walled sensor housing comprises:
an interior wall, wherein the high voltage electrode, the detection electrode, and the insulating material are located within an interior cavity defined by the interior wall;
an exterior wall outside of the interior wall, wherein the exterior wall is configured to shield the interior wall against heat removal by the exhaust stream; and
apertures in the interior and exterior walls to allow a portion of the exhaust stream to enter the interior cavity defined by the interior wall.

26. The ceramic particulate matter sensor of claim 1, further comprising an electronic controller coupled to the high voltage electrode and the detection electrode, wherein the electronic controller is configured to determine an operational status of a particulate trap within the exhaust stream.

27. The ceramic particulate matter sensor of claim 26, wherein the electronic controller is further configured to compare an output voltage from the high voltage electrode and the detection electrode with a threshold voltage level and to initiate an alarm operation to notify a user of a failure of the particulate trap within the exhaust stream in response to a determination that the output voltage exceeds the threshold voltage level.

28. The ceramic particulate matter sensor of claim 1, further comprising:
a sensor housing to enclose the high voltage electrode, the detection electrode, and the insulating material;
first and second sealant rings to circumscribe portions of the high voltage electrode, the detection electrode, and the insulating material, wherein the first and second sealant rings define a sealant cavity between the first and second sealant rings; and
a pliable sealant within the sealant cavity between the first and second sealant rings, wherein the pliable sealant is configured to circumscribe at least a portion of the high voltage electrode, the detection electrode, and the insulating material.

29. The ceramic particulate matter sensor of claim 28, wherein the pliable sealant comprises a powder sealant, wherein crimping of the sensor housing at about a location of the powder sealant within the sensor housing compacts the powder sealant to form a seal around the high voltage electrode, the detection electrode, and the insulating layer within the sensor housing, wherein the seal is substantially impervious to the particulate matter.

30. The ceramic particulate matter sensor of claim 28, wherein the pliable sealant comprises a melting sealant, wherein application of heat to the melting sealant melts the melting sealant to form a seal around the high voltage electrode, the detection electrode, and the insulating layer within the sensor housing, wherein the seal is substantially impervious to the particulate matter.

31. The ceramic particulate matter sensor of claim 1, further comprising:
a high voltage electrode substrate, wherein the high voltage electrode is disposed on the high voltage electrode substrate;
a detection electrode substrate, wherein the detection electrode is disposed on the detection electrode substrate; and
an insulting spacer between the high voltage electrode substrate and the detection electrode substrate at an electrode end of the high voltage and detection electrode substrates.

32. A ceramic particulate matter sensor comprising:
a high voltage electrode on a first conductive layer within a stack of ceramic layers, wherein the stack of ceramic layers is bonded as a single rigid structure;
a detection electrode on a second conductive layer within the stack of ceramic layers, the detection electrode positioned relative to the high voltage electrode to generate a measurement of particulate matter within an exhaust stream between the high voltage electrode and the detection electrode; and
a substantially pure insulating material positioned between the high voltage electrode and the detection electrode, the substantially pure insulating material to electrically insulate between the high voltage electrode and the detection electrode.

33. The ceramic particulate matter sensor of claim 32, wherein the substantially pure insulating material comprises at least 99% pure alumina.

34. The ceramic particulate matter sensor of claim 32, wherein the substantially pure insulating material comprises at least 99.9% pure alumina.

35. The ceramic particulate matter sensor of claim 32, wherein the insulating material comprises a ceramic material with an electrical resistivity of at least about 20 M-ohms.

36. The ceramic particulate matter sensor of claim 32, wherein the substantially pure insulating material comprises a ceramic material with an electrical resistivity of at least about 100 M-ohms.

37. The ceramic particulate matter sensor of claim 32, wherein the insulating material comprises a ceramic material with an electrical stability during application of a high voltage of at least about 3,000 V to the ceramic material.

38. The ceramic particulate matter sensor of claim 32, further comprising:
an electrical heater positioned relative to the detection electrode to burn off an accumulation of contaminating particulate matter from a region of the detection electrode; and
a detection electrode substrate interposed between the electrical heater and the detection electrode, wherein the detection electrode substrate comprises a substantially pure insulating material to electrically insulate between the electrical heater and the detection electrode.

39. A particulate matter sensor comprising:
a high voltage electrode;
a detection electrode positioned relative to the high voltage electrode to generate a measurement of particulate matter within an exhaust stream; and
a precharging electrode positioned within the exhaust stream prior to the high voltage electrode and the detection electrode, wherein the precharging electrode is configured to charge the particulate matter within the exhaust stream.

40. The particulate matter of claim 39, wherein the precharging electrode is further configured to impart a surface charge to the particulate matter within the exhaust stream prior to passage between the high voltage electrode and the detection electrode.

41. The particulate matter sensor of claim 39, wherein the precharging electrode comprises a conductive ring.

42. The particulate matter sensor of claim 39, wherein the precharging electrode comprises a conductive cylinder.

43. The particulate matter sensor of claim 39, wherein the precharging electrode comprises a conductive plate.

44. The particulate matter sensor of claim 39, further comprising a power source coupled to the precharging electrode, wherein the power source is configured to supply a voltage signal to the precharging electrode, wherein the voltage signal is between about 0.1 V and 10,000 V.

45. The particulate matter sensor of claim 44, wherein the voltage signal is between about 1 V and 3,000 V.

46. The particulate matter sensor of claim 44, wherein the voltage signal is between about 500 V and 1,500 V.

47. The particulate matter sensor of claim 44, wherein the voltage signal is about 1,000 V.

48. The particulate matter sensor of claim 44, wherein the power source is further configured to continuously supply the voltage signal to the precharging electrode.

49. The particulate matter sensor of claim 44, wherein the power source is further configured to intermittently supply the voltage signal to the precharging electrode.

50. A particulate matter sensor comprising:
a high voltage electrode;
a detection electrode positioned relative to the high voltage electrode to generate a measurement of particulate matter within an exhaust stream;
an electrical heater positioned relative to the high voltage and detection electrodes to burn off an accumulation of contaminating particulate matter from at least one electrode of the high voltage and detection electrodes; and
a double-walled sensor housing to contain the high voltage electrode, the detection electrode, and the electrical heater, wherein the double-walled sensor housing is configured to an operating temperature within the double-walled sensor housing sufficient to burn off the accumulation of the contaminating particulate matter.

51. The particulate matter sensor of claim 50, wherein the double-walled sensor housing is configured to substantially shield the electrical heater from the exhaust stream.

52. The particulate matter sensor of claim 50, wherein the double-walled sensor housing comprises:
an interior wall, wherein the high voltage electrode, the detection electrode, and the electrical heater are located within an interior cavity defined by the interior wall;
an exterior wall outside of the interior wall, wherein the exterior wall is configured to shield the interior wall against heat removal by the exhaust stream; and
apertures in the interior and exterior walls to allow a portion of the exhaust stream to enter the interior cavity defined by the interior wall.
